(19) United States
(12) Patent Application Publication
(10) Pub. No.: US 2023/0059288 A1
(43) Pub. Date: Feb. 23, 2023

(54) LIQUID ELECTROPHOTOGRAPHIC INK COMPOSITION

(71) Applicant: Hewlett-Packard Development Company, L.P., Spring, TX (US)

(72) Inventors: Gil Bar-Haim, Nes Ziona (IL); Daniel Skvirsky, Nes Ziona (IL); Albert Teishev, Nes Ziona (IL)

(21) Appl. No.: 17/392,950

(22) Filed: Aug. 3, 2021

(51) Int. Cl. C09D 11/037; C09D 11/10

(52) U.S. Cl. CPC C09D 11/037; C09D 11/10

(57) ABSTRACT

A liquid electrophotographic (LEP) ink composition is described. The composition comprises: a pigment particle having an acidic surface modification; a basic charge director selected from:(i) a polymeric amine dispersant having a Total Base Number of at least 100 mg KOH/gram material, and (ii) a sulfosuccinate salt of the general formula MAₙ, wherein M is a metal, n is the valence of M, and A is an ion of the general formula (I): [R¹—O—C(O)CH₂CH(SO₃)C(O)—O—R²]⁻ (I); and a liquid carrier. The ink composition does not include a thermoplastic resin. Also described are a method of producing the ink composition, and a method of printing using the ink composition.

### BACKGROUND

Electrophotographic printing processes, sometimes termed electrostatic printing processes, typically involve creating an image on a photoconductive surface, applying an ink having chargeable particles to the photoconductive surface, such that they selectively bind to the image, and then transferring the chargeable particles in the form of the image to a print substrate. The chargeable particles are created by grinding pigment particles with particles of chargeable polymer resin.

The photoconductive surface may be on a cylinder and is often termed a photo imaging plate (PIP). The photoconductive surface is selectively charged with a latent electrostatic image having image and background areas with different potentials. For example, an electrostatic ink composition including chargeable particles in a liquid carrier can be brought into contact with the selectively charged photoconductive surface. The chargeable particles adhere to the image areas of the latent image while the background areas remain clean. The image is then transferred to a print substrate (e.g., a polymer substrate) directly or by being first transferred to an intermediate transfer member, which can be a soft swelling blanket, which is often heated to fuse the solid image and evaporate the liquid carrier, and then to the print substrate.

### DETAILED DESCRIPTION

Before the compositions, methods and related aspects of the disclosure are disclosed and described, it is to be understood that this disclosure is not restricted to the particular process features and materials disclosed herein because such process features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a”, “an”, and “the” include plural referents unless the context clearly dictates otherwise.

As used herein, “electrophotographic ink composition” or “electrostatic ink composition” generally refers to an ink composition, which may be in liquid form, generally suitable for use in an electrostatic printing process, sometimes termed an electrophotographic printing process. The electrophotographic ink composition may include chargeable particles suspended in a liquid carrier, which may be as described herein.

As used herein, “liquid carrier”, “carrier”, or “carrier vehicle” refer to the fluid in which a pigment particle can be dispersed to form a liquid electrostatic ink. Liquid carriers can include a mixture of a variety of different agents, such as surfactants, co-solvents, viscosity modifiers, humectants, sequestering agents, buffers, biocides and/or other possible ingredients.

As used herein, “total base number” (TBN), sometimes simply referred to as base number, may be determined using standard techniques, including, those laid out in ASTM Designation D4739-08, such as Test Method D2896, Test Method D4739, and ASTM Designation D974-08, with Test Method D2896 being used if any discrepancy is shown between test methods, and unless otherwise stated, the test method(s) will be the most recently published at the time of filing this patent application. “mgKOH/g material” indicates “mgKOH per gram of sample”. The measurement of TBN of the dispersant can either be on the pure dispersant, or a dispersant in water or a hydrocarbon liquid, such as 60 wt % dispersant in white spirit, e.g. dearomatized white spirit, mineral oil or distillate (e.g. C₁₀₋₂₀ hydrocarbons), and then adjusted as if it had been measured on the pure dispersant.

As used herein, “liquid electrostatic(ally) printing” or “liquid electrophotographic(ally) printing” generally refers to the process that provides an image that is transferred from a photo imaging substrate or plate either directly or indirectly via an intermediate transfer member to a print substrate, for example, a polymer substrate. As such, the image is not substantially absorbed into the photo imaging substrate or plate on which it is applied. Additionally, “liquid electrophotographic printers” or “liquid electrostatic printers” generally refer to those printers capable of performing electrophotographic printing or electrostatic printing, as described above. A liquid electrophotographic (LEP) printing process may involve subjecting a liquid electrophotographic ink composition to an electric field, for example, an electric field having a field strength of 1000 V/cm or more, in some examples, 1000 V/mm or more.

As used herein, “low field conductivity” refers to the electrical conductivity of an ink and is measured by applying a constant amplitude AC voltage to two parallel electrodes and monitoring the current via the fluid. Since the conductivity per definition is proportional to the current and inversely proportional to the voltage inducing the current, the conductivity can be calculated by multiplying the current by a factor depending only on the constant values of the voltage amplitude and geometric parameters, i.e. electrodes surface and distance between the electrodes. The present low field conductivities were measured at the following conditions: electrical field amplitude: 5-15 V/mm, frequency: 5-15 Hz, and temperature: 23+/−2 C.

As used herein, “high field conductivity” refers to the maximum electrical conductivity of the ink measured at the following conditions: electrical field pulse—shape: rectangular; height: 1500 V/mm; duration: 8 sec, rise time: 1 ms or less; ripple: 10 V/mm or less; sampling frequency: 1000 per second; and temperature: 23+/−2 C.

As used herein, “direct conductivity” refers to the average conductivity of the ink measured between 6.4 and 7.2 seconds and was measured by applying a constant high voltage to two parallel electrodes and monitoring the current via the fluid. Since the conductivity per definition is proportional to the current and inversely proportional to the voltage inducing the current, the conductivity can be calculated by multiplying the current by a factor depending only on the constant values of the voltage amplitude and geometric parameters, i.e. electrodes surface and distance between the electrodes. The conductivity of the ink measured in constant electrical field is varying (actually declining) with time. As such, the maximum value of the conductivity is defined as the “high field conductivity” as noted above, and the “direct conductivity” is the conductivity at the tail of the conductivity vs. time curve when the conductivity has leveled off.

As used herein, “particle conductivity” refers to the difference between the high field conductivity and the low field conductivity as defined above. The particle conductivity is proportional to the ink particle properties; i.e., mobility and electrical charge created on the particles.

As used herein, “LEP image” or “printed LEP image” refer to an image which has been printed, for example, on a print substrate, by liquid electrophotographically printing a LEP ink composition described herein.

As used herein, “NVS” is an abbreviation of the term “non-volatile solids”.

As used herein, the term “about” is used to provide flexibility to a numerical range endpoint by providing that a given value may be a little above or a little below the endpoint. The degree of flexibility of this term can be dictated by the particular variable.

If a standard test is mentioned herein, unless otherwise stated, the version of the test to be referred to is the most recent at the time of filing this patent application.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and subranges within the indicated range. Thus, included in this numerical range are individual values such as 2, 3.5, and 4 and sub-ranges such as from 1-3, from 2-4, and from 3-5, and so on. This same principle applies to ranges reciting a single numerical value. Furthermore, such an interpretation should apply regardless of the breadth of the range or the characteristics being described.

As used herein, unless specified otherwise, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a liquid electrophotographic (LEP) ink composition, comprising:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier wherein the ink composition does not include a thermoplastic resin.

In a second aspect there is provided a method of manufacturing a liquid electrophotographic (LEP) ink composition, comprising combining:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier wherein the ink composition does not include a thermoplastic resin.

In a third aspect there is provided a method of electrophotographic printing, comprising:
forming a latent electrophotographic image on a surface; and
contacting the surface with a liquid electrophotographic (LEP) composition comprising:
   a pigment particle having an acidic surface modification;
   a basic charge director selected from:
      (i) a polymeric amine dispersant having a Total Base Number of at least 100 mg KOH/gram material, and
      (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier, wherein the ink composition does not include a thermoplastic resin, such that at least some of the particles adhere to the surface to form a developed toner image on the surface; and
transferring the toner image to a print medium.

In a fourth aspect there is provided a printed substrate, having thereon a printed image consisting of a pigment particle having an acidic surface modification.

Liquid electrophotographic ink compositions often use chargeable particles of thermoplastic polymer resins associated with a pigment particle to facilitate transfer of the pigment during the printing process. The present inventors have surprisingly found that good levels of particle conductivity of a pigment particle can be obtained, and thus the pigment particle can be electrophotographically printed, when the pigment particle is not associated with a polymer resin, but has an acidic surface modification and is combined with a basic charge director as described herein.

### Liquid Electrophotographic (LEP) Ink Composition

Described herein is a liquid electrophotographic (LEP) ink composition, comprising:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier, wherein the ink composition does not include a thermoplastic resin.

The liquid electrophotographic ink composition may consist of:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier.

The liquid electrophotographic ink composition may consist essentially of:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier.

For the avoidance of doubt, the general description which follows is applicable to each of the afore-mentioned liquid electrophotographic ink compositions.

In some examples, the ink composition is a yellow ink composition.

### Pigment

The pigment comprises an acidic surface modification. As used herein, the term “acidic surface modification” refers to a functionalisation of the pigment surface to incorporate an acid group onto the surface. The term is not intended to encompass an intimate mixing of the pigment particle with other particles, in particular particles of polymer resin that render the blended particles as chargeable particles.

In some examples, the pigment is a yellow pigment.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C. I. Pigment Yellow 172, C.I. Pigment Yellow 180, and C. I. Pigment Yellow 185.

The pigment comprises an acidic surface modification. In some examples, the pigment may be referred to as an acidic pigment. As used herein, the terms “acidic surface modification” or “acidic pigment” refer to a particulate pigment that has acidic groups on the surface of the particles of the pigment. The acidic groups may be within the molecular structure of the pigment molecule, or they may be non-covalently adsorbed onto to the surface of the pigment.

An acidic pigment, or a pigment having an acidic surface modification, may be defined as a pigment that, when in water at 20° C., has a pH value of less than 7, in some examples less than 6, in some examples less than 5, in some examples less than 4, in some examples less than 3.

In some examples, an acidic pigment comprises particles comprising a pigment and a compound, for example, a small molecule containing acidic groups adsorbed onto the surface of the pigment particle. In some examples, the pigment is a mildly acidic pigment, for example a pigment having a pH, when in water at 20° C., in the range of about 3 to less than about 7, about 4 to less than about 7, about 5 to less than about 7, or about 6 to less than about 7. Methods of determining the pH of a substance are well known to the skilled person, for example the method described in ISO Standard 31-8 Annex C. pH may be measured in water at 20° C. In some examples, the total acid number of an acidic pigment may be determined by measuring the number of acid groups neutralized by titration with an alkali.

The acidic groups that render the pigment acidic may be present on a molecule adsorbed onto the surface of the pigment. The acidic groups may be present on a molecule having a molecular weight less less than 100 Da, for example less than 500 Da, for example less than 400 Da, for example less than 300 Da, for example less than 200 Da, for example about 100 Da or less. Thus, the acidic groups are not present as side chain acidic functionalities on a thermoplastic resin which at least partially encapsulates the pigment particle. That is, the ink composition does not include a thermoplastic resin. Instead, the acidic groups are present on small molecule organic acids (i.e. having a molecular weight as set out above), or inorganic acids. In other examples, the acidic groups may be present on a nucleic acid oligomer or polymer adsorbed to a surface of the pigment.

The acidic surface modification of the pigment may comprise or derive from a Bronsted-Lowry acid. The acidic surface modification may comprise an organic acid, a sulfonic acid or an inorganic acid, or a mixture thereof, adsorbed onto the surface of the pigment particle. The acidic surface modification of the pigment may comprise or derive from a carboxylic acid such as methanoic acid, ethanoic acid, propionic acid, butanoic acid, pentanoic acid or hexanoic acid, or any other organic carboxylic acid such as oxalic acid, maleic acid, tartaric acid, citric acid, succinic acid, benzoic acid, stearic acid, gallic acid, salicylic acid, ascorbic acid and mixtures thereof. The acidic surface modification of the pigment may comprise or derive from a sulfonic acid including but not limited to methanesulfonic acid, benzenesulfonic acid, p-toluenesulfonic acid, triflic acid and taurine and mixtures thereof. The acidic surface modification of the pigment may comprise or derive from an inorganic acid such as hydrofluoric acid, hydrochloric acid, hydrobromic acid, hydroiodic acid, nitric acid, nitrous acid, sulfuric acid, boric acid, phosphoric acid, or perchloric acid and mixtures thereof.

The acidic surface modification may comprise or derive from a Lewis acid, which accepts a pair of electrons from an electron donor, or Lewis base. The acidic surface modification may comprise or derive from borane, a boron trihalide, for example boron trifluoride, or an organoborane, or silicon tetrafluoride, or an aluminium trihalide.

The acidic surface modification comprises an organic acid, a sulfonic acid or an inorganic acid adsorbed onto the surface of the pigment particle, or a Lewis acid selected from borane, a boron trihalide, for example boron trifluoride, or an organoborane, or silicon tetrafluoride, or an aluminium trihalide adsorbed onto the surface of the pigment particle.

In some examples, the pigment particles may have a median particle size (particle diameter) or d₅₀ of 20 μm or less, for example, 15 μm or less, for example, 10 μm or less, for example, 5 μm or less, for example, 4 μm or less, for example, 3 μm or less, for example, 2 μm or less, for example, 1 μm or less, for example, 0.9 μm or less, for example, 0.8 μm or less, for example, 0.7 μm or less, for example, 0.6 μm or less, for example, 0.5 μm or less, for example, 0.4 μm or less, for example, 0.3 μm or less, for example, 0.2 μm or less, for example, 0.1 μm or less, for example, about 0.05 μm. In some examples, the pigment particles may have a median particle size (particle diameter) or d₅₀ of greater than 0.05 μm, for example, greater than 0.1 μm, for example, greater than 0.2 μm, for example, greater than 0.3 μm, for example, greater than 0.4 μm, for example, greater than 0.5 μm, for example, greater than 0.6 μm, for example, greater than 0.7 μm, for example, greater than 0.8 μm, for example, greater than 0.9 μm, for example, greater than 1 μm, for example, greater than 2 μm, for example, greater than 3 μm, for example, greater than 4 μm, for example, greater than 5 μm, for example, greater than 10 μm, for example, greater than 15 μm, for example, about 20 μm. In some examples, the pigment particles may have a median particle size (particle diameter) or d₅₀ of from 0.05 μm to 20 μm, for example from 0.1 μm to 15 μm, for example from 0.2 μm to 10 μm, for example from 0.3 μm to 5 μm, for example from 0.4 μm to 5 μm, for example from 0.5 μm to 4 μm, for example from 0.6 μm to 3 μm, for example from 0.7 μm to 2 μm, for example from 0.8 μm to 1 μm. Unless otherwise stated, the particle size of the pigment particle is determined using laser diffraction on a Malvern Mastersizer 2000 according to the standard procedure as described in the operating manual.

The surface of the pigment particle may be rendered acidic by grafting of the acid group-containing molecule onto the surface in a vapour deposition process in a gas chamber, for volatile acid group-containing molecules. Alternatively, the surface of the pigment particle may be rendered acidic in a solution based process, in which the pigment particle is dissolved into an acidic solution, followed by drying of the pigment particle, leaving the acidic groups physically adsorbed onto the surface of the pigment particle. The pigment may be present in an ink composition in an amount of at least 5 wt %, based on the total weight of the composition, for example from 10 wt. % to 90 wt. % of the total amount of solids in the ink composition, in some examples, 30 wt. % to 80 wt. %, in some examples, 40 wt. % to 70 wt. %, in some examples, 45 wt. % to 70 wt. % of the total amount of solids in the ink composition.

### Basic Charge Director

The liquid electrophotographic ink composition comprises a basic charge director selected from:
(i) a polymeric amine dispersant having a Total Base Number of at least 100 mg KOH/gram material, and
(ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I)

The basic charge director may be added in order to impart and/or maintain sufficient electrostatic charge on the pigment particles during electrostatic printing. The charge director can impart a negative charge or a positive charge on the chargeable particles of an electrostatic ink composition and disperse the pigment particles.

### Polymeric Amine Dispersant

The ink composition may comprise a polymeric amine dispersant having a total base number (TBN) of at least about 100 mgKOH/g material. The amine-containing basic dispersant may be present in the ink composition in an amount of up to about 10 wt. % by weight of the pigment. The polymeric amine dispersant having a TBN greater than about 100 mgKOH/g material may be termed an amine-containing dispersant or a basic polymeric dispersant herein.

In some examples, the basic polymeric dispersant comprises a basic anchor group, that is, an amine group. In some examples, each basic polymeric dispersant molecule comprises a multi amine anchor group or a single amine anchor group, in some examples each basic polymeric dispersant molecule comprises a multi amine anchor group. In some examples, the basic polymeric dispersant comprises a polyester. In some examples, the basic polymeric dispersant comprises a polyester and an amine anchor group. In some examples, the basic polymeric dispersant comprises a polyester terminated by an amine containing group bound to the polyester through an amide linkage. In some examples, the polymeric amine dispersant comprises a copolymer having pendant stearic acid groups. In some examples, the polymeric amine dispersant comprises a polyhydroxy stearic acid chain.

In some examples, the basic polymeric dispersant comprises a co-polymer. In some examples, the basic polymeric dispersant comprises a block co-polymer having multiple anchor groups, for example an ABA block co-polymer or a BAB block co-polymer or a random copolymer. In some examples, the polymeric dispersant comprises a comb co-polymer.

In some examples, the amine-containing basic dispersant has a total base number (TBN) of at least about 200 mgKOH/g material, in some examples, a TBN of at least about 250 mgKOH/g material, in some examples, a TBN of at least about 300 mgKOH/g material, in some examples, a TBN of at least about 310 mgKOH/g material, in some examples, a TBN of at least about 320 mgKOH/g material, in some examples, a TBN of at least about 330 mgKOH/g material, in some examples, a TBN of at least about 340 mgKOH/g material, in some examples, 350 mgKOH/g material, in some examples a TBN of at least about 360 mgKOH/g material, in some examples a TBN of at least about 370 mgKOH/g material, in some examples a TBN of at least about 380 mgKOH/g material, in some examples a TBN of at least about 390 mgKOH/g material, in some examples a TBN of about 400 mgKOH/g material. In some examples, amine-containing basic dispersant has a TBN of about 450 mgKOH/g material or less, in some examples a TBN of about 440 mgKOH/g material or less, in some examples a TBN of about 430 mgKOH/g material or less, in some examples a TBN of about 420 mgKOH/g material or less, in some examples a TBN of about 410 mgKOH/g material or less. In some examples the basic dispersant has a total base number (TBN) of from about 100 mgKOH/g material to about 450 mgKOH/g material, in some examples from about 200 mgKOH/g material to about 445 mgKOH/g material, in some examples from about 250 mgKOH/g material to about 440 mgKOH/g material, in some examples from about 300 mgKOH/g material to about 435 mgKOH/g material, in some examples from about 325 mgKOH/g material to about 430 mgKOH/g material, in some examples from about 350 mgKOH/g material to about 425 mgKOH/g material, in some examples from about 355 mgKOH/g material to about 420 mgKOH/g material, in some examples from about 360 mgKOH/g material to about 415 mgKOH/g material, in some examples from about 365 mgKOH/g material to about 410 mgKOH/g material, in some examples from about 370 mgKOH/g material to about 405 mgKOH/g material, in some examples from about 375 mgKOH/g material to about 405 mgKOH/g material, in some examples from about 380 mgKOH/g material to about 400 mgKOH/g material, in some examples from about 385 mgKOH/g material to about 450 mgKOH/g material, in some examples from about 390 mgKOH/g material to about 445 mgKOH/g material, in some examples from about 395 mgKOH/g material to about 405 mgKOH/g material.

In some examples, the amine-containing basic dispersant has a total base number (TBN) of from about 300 mgKOH/g material to about 500 mgKOH/g material, in some examples from about 380 mgKOH/g material to about 420 mgKOH/g material, in some examples about 400 mgKOH/g material.

In some examples, the amine-containing basic dispersant has a total base number (TBN) of less than about 500 mgKOH/g material, in some examples less than about 450 mgKOH/g material, in some examples less than about 425 mgKOH/g material, in some examples less than about 420 mgKOH/g material, in some examples less than about 410 mgKOH/g material.

In some examples, the dispersant has a weight average molecular weight (MW) of about 2 kg/mol or more, for example, about 2.1 kg/mol or more, about 2.2 kg/mol or more, about 2.3 kg/mol or more, about 2.4 kg/mol or more, about 2.5 kg/mol or more, about 2.6 kg/mol or more, about 2.7 kg/mol or more, about 2.8 kg/mol or more, about 2.9 kg/mol or more, or about 3 kg/mol. In some examples, the dispersant has a weight average molecular weight (MW) of about 5 kg/mol or less, for example, about 4.9 kg/mol or less, about 4.8 kg/mol or less, about 4.7 kg/mol or less, about 4.6 kg/mol or less, about 4.5 kg/mol or less, about 4.4 kg/mol or less, about 4.3 kg/mol or less, about 4.2 kg/mol or less, about 4.1 kg/mol or less, or about 4 kg/mol. In some examples, the dispersant has a weight average molecular weight (MW) of from about 2 kg/mol to about 5 kg/mol, for example, from about 2.1 kg/mol to about 4.9 kg/mol, from about 2.2 kg/mol to about 4.8 kg/mol, from about 2.3 kg/mol to about 4.7 kg/mol, from about 2.4 kg/mol to about 4.6 kg/mol, from about 2.5 kg/mol to about 4.5 kg/mol, from about 2.6 kg/mol to about 4.4 kg/mol, from about 2.7 kg/mol to about 4.3 kg/mol, from about 2.8 kg/mol to about 4.2 kg/mol, from about 2.9 kg/mol to about 4.1 kg/mol, or from about 3 kg/mol to about 4 kg/mol. In some examples, the dispersant may have a weight average molecular weight of about 3.5 kg/mol.

In some examples, the polymeric amine dispersant comprises Solplus™ P6000 (available from Lubrizol™), which has a TBN of about 400 mgKOH/g material. The polymeric amine dispersant may comprise Solsperse™ 13300, which is a 50% actives dispersant in SHELLSOL™ D40, also available from Lubrizol™ and which has a TBN of about 200-250 mgKOH/g material, or Solsperse™ 13940 and Solsperse™ 13500 which both have a similar TBN. The polymeric amine may comprise OS 133309, also from Lubrizol™ and having a lower TBN of ˜120.

In some examples, the polymeric amine dispersant may be present as a solution or dispersion of the active dispersant in a carrier fluid prior to be added to the ink composition. In some examples, the polymeric amine dispersant may be present as a 50% actives solution in a carrier fluid, such as a mineral oil or dipropylene glycol.

In some examples, the ink composition comprises a polymeric amine dispersant in an amount up to about 100 wt. % by weight of the pigment, for example up to about 90 wt. %, up to about 75 wt. %, up to about 50 wt. % by weight of the pigment, based on the amount of active dispersant.

In some examples, the ink composition comprises polymeric amine dispersant in an amount of at least about 0.2 wt. % by weight of the total solids in the ink composition, for example at least about 0.5 wt. %, for example at least about 1 wt. %, for example at least about 2 wt. %, for example at least about 5 wt. %, for example at least about 10 wt. %, for example at least about 20 wt. %, for example at least about 30 wt. %, at least about 40 wt. %, at least about 50 wt. %, at least about 60 wt. %, at least about 70 wt. %, at least about 80 wt. %, at least about 90 wt. %, about 100 wt. % by weight of the pigment, based on the amount of active dispersant.

In some examples, the ink composition comprises polymeric amine dispersant in an amount in the range of about 0.2 wt. % to about 100 wt. % by weight of the pigment, for example, about 1 wt. % to about 90 wt. %, about 2 wt. % to about 80 wt. %, about 5 wt. % to about 75 wt. %, for example, about 10 wt. % to about 60 wt. %, for example, about 15 wt. % to about 50 wt. %, for example, about 20 wt. % to about 30 wt. %, by weight of the pigment, based on the amount of active dispersant.

In some examples, the polymeric amine dispersant is present in an amount to provide an agent on weight of pigment (AOWP) percentage of from 0.1% to 50%, for example from 1% to 50%, for example from 5% to 50%, for example from 10% to 40%, for example from 15% to 35%, for example from 20% to 30%.

### Sulfosuccinate Salt

In some examples, the ink composition includes a charge director comprising a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I)

wherein each of R¹ and R² is an alkyl group.

The sulfosuccinate salt of the general formula MAₙ is an example of a micelle forming salt in an isoparaffinic carrier liquid. The charge director may include micelles of said sulfosuccinate salt enclosing nanoparticles of a metal cation and anionic counter ion. For example, the sulfosuccinate may enclose nanoparticles of a simple salt selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof. The charge director may include at least some nanoparticles having a size of 200 nm or less, and/or, in some examples, 2 nm or more.

In the formula [R¹—O—C(O)CH₂CH(SO₃⁻)C(O)—O—R²], in some examples, each of R¹ and R² is an aliphatic alkyl group. In some examples, each of R¹ and R² independently is a C3 to C30 alkyl, for example, C6-25 alkyl, C10 to C20 alkyl or C11 to C15 alkyl. In some examples, R¹ and R² are both C13 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same or different. In some examples, R¹ and R² are the same. In some examples, at least one of R¹ and R² is C₁₃H₂₇. In some examples, M is Na, K, Cs, Ca, or Ba.

In some examples, the ink composition comprises the sulfosuccinate salt dispersant in an amount up to about 100 wt. % by weight of the pigment, for example up to about 90 wt. %, up to about 75 wt. %, up to about 50 wt. % by weight of the pigment, based on the amount of active dispersant.

In some examples, the ink composition comprises the sulfosuccinate salt dispersant in an amount of at least about 0.2 wt. % by weight of the total solids in the ink composition, for example at least about 0.5 wt. %, for example at least about 1 wt. %, for example at least about 2 wt. %, for example at least about 5 wt. %, for example at least about 10 wt. %, for example at least about 20 wt. %, for example at least about 30 wt. %, at least about 40 wt. %, at least about 50 wt. %, at least about 60 wt. %, at least about 70 wt. %, at least about 80 wt. %, at least about 90 wt. %, about 100 wt. % by weight of the pigment, based on the amount of active dispersant.

In some examples, the ink composition comprises the sulfosuccinate salt dispersant in an amount in the range of about 0.2 wt. % to about 100 wt. % by weight of the pigment, for example, about 1 wt. % to about 90 wt. %, about 2 wt. % to about 80 wt. %, about 30 wt. % to about 75 wt. % by weight of the pigment, for example, about 10 wt. % to about 60 wt. %, for example, about 15 wt. % to about 50 wt. %, for example, about 20 wt. % to about 30 wt. %, based on the amount of active dispersant.

In some examples, the sulfosuccinate salt dispersant is present in an amount to provide an agent on weight of pigment (AOWP) percentage of from 0.1% to 50%, for example from 1% to 50%, for example from 5% to 50%, for example from 10% to 40%, for example from 15% to 35%, for example from 20% to 30%.

In some examples, the basic charge director is present in the composition in an amount of from 1 to 20 wt %, based on the amount of active charge dispersant in the total weight of the composition, for example from 2 to 10 wt %, for example from 2 to 15 wt %, for example from 5 to 10 wt %.

In some examples, the basic charge director is present in the ink composition in an amount of at least 0.2 wt. %, for example in the range of about 0.2 wt. % to about 100 wt. % by weight of the pigment, for example, about 1 wt. % to about 90 wt. %, about 2 wt. % to about 80 wt. %, about 30 wt. % to about 75 wt. % by weight of the pigment, for example, about 10 wt. % to about 60 wt. %, for example, about 15 wt. % to about 50 wt. %, for example, about 20 wt. % to about 30 wt. %, based on the amount of active charge director.

In some examples, the basic charge director is present in an amount to provide an agent on weight of pigment (AOWP) percentage of from 0.1% to 50%, for example from 1% to 50%, for example from 5% to 50%, for example from 10% to 40%, for example from 15% to 35%, for example from 20% to 30%.

In some examples, the charge director is present in an amount sufficient to achieve a particle conductivity of 2000 pmho/cm or less, 1500 pmho/cm or less, 1000 pmho/cm or less, 800 pmho/cm or less, in some examples, 700 pmho/cm or less, in some examples, 600 pmho/cm or less, in some examples, 500 pmho/cm or less, in some examples, 400 pmho/cm or less, in some examples, 300 pmho/cm or less, in some examples, 200 pmho/cm or less, in some examples, 190 pmho/cm or less, in some examples, 180 pmho/cm or less, in some examples, 170 pmho/cm or less, in some examples, 160 pmho/cm or less, in some examples, 150 pmho/cm or less, in some examples, 140 pmho/cm or less, in some examples, 130 pmho/cm or less, in some examples, 120 pmho/cm or less, in some examples, 110 pmho/cm or less, in some examples, about 100 pmho/cm.

In some examples, the charge director is present in an amount sufficient to achieve a particle conductivity of 50 pmho/cm or more, in some examples, 100 pmho/cm or more, in some examples, 110 pmho/cm or more, in some examples, 120 pmho/cm or more, in some examples, 130 pmho/cm or more, in some examples, 140 pmho/cm or more, in some examples, 150 pmho/cm or more, in some examples, 160 pmho/cm or more, in some examples, 170 pmho/cm or more, in some examples, 180 pmho/cm or more, in some examples, 190 pmho/cm or more, in some examples, 200 pmho/cm or more, in some examples, 300 pmho/cm or more, in some examples, 400 pmho/cm or more, in some examples, 500 pmho/cm or more, in some examples, 600 pmho/cm or more, in some examples, 700 pmho/cm or more, in some examples, 800 pmho/cm or more, in some examples, 1000 pmho/cm or more, in some examples, 1500 pmho/cm or more, in some examples, about 2000 pmho/cm.

In some examples, the charge director is present in an amount sufficient to achieve a particle conductivity of 50 pmho/cm to 2000 pmho/cm, in some examples, 75 pmho/cm to 1500 pmho/cm, in some examples, 200 pmho/cm to 1000 pmho/cm, in some examples, 300 pmho/cm to 800 pmho/cm.

### Liquid Carrier

The liquid electrophotographic ink composition includes a liquid carrier. Generally, the liquid carrier can act as a dispersing medium for the other components in the ink composition. For example, the liquid carrier can comprise or be a hydrocarbon, silicone oil, vegetable oil, or the like. The liquid carrier can include, but is not limited to, an insulating, non-polar, non-aqueous liquid that can be used as a medium for toner particles. The liquid carrier can include compounds that have a resistivity in excess of about 109 ohm·cm. The liquid carrier may have a dielectric constant below about 5, in some examples, below about 3. The liquid carrier can include, but is not limited to, hydrocarbons. The hydrocarbon can include, but is not limited to, an aliphatic hydrocarbon, an isomerized aliphatic hydrocarbon, a branched chain aliphatic hydrocarbon, an aromatic hydrocarbon, and combinations thereof. Examples of the liquid carrier include, but are not limited to, aliphatic hydrocarbons, isoparaffinic compounds, paraffinic compounds, dearomatized hydrocarbon compounds, and the like. In particular, the liquid carrier can include, but is not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before electrostatic printing, the liquid carrier can constitute about 20% to 99.5% by weight of the ink composition, in some examples, 50% to 99.5% by weight of the electrostatic ink composition. Before printing, the liquid carrier may constitute about 40 to 90% by weight of the electrostatic ink composition. Before printing, the liquid carrier may constitute about 60% to 90% by weight of the electrostatic ink composition.

The ink, when printed, may be substantially free from liquid carrier. In an electrostatic printing process and/or afterwards, the liquid carrier may be removed, for example, by an electrophoresis processes during printing and/or evaporation, such that substantially just solids are transferred to the substrate. Substantially free from liquid carrier may indicate that the ink printed on the substrate contains less than 5 wt. % liquid carrier, in some examples, less than 2 wt. % liquid carrier, in some examples, less than 1 wt. % liquid carrier, in some examples, less than 0.5 wt. % liquid carrier. In some examples, the ink printed on the substrate is free from liquid carrier.

### Additives

The ink composition may include an additive or a plurality of additives. The additive or plurality of additives may be added at any stage of the method of producing the ink composition. The additive or plurality of additives may be selected from a wax, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, for example, from an intermediate transfer member, which may be a heated blanket.

### Method of Manufacturing the Ink Composition

Described herein is a method of manufacturing a liquid electrophotographic (LEP) ink composition, comprising combining:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier, wherein the ink composition does not include a thermoplastic resin.

Also described is a method of manufacturing a liquid electrophotographic (LEP) ink composition, comprising combining:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier.

Also described is a method of manufacturing a liquid electrophotographic (LEP) ink composition consisting of:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier,
the method comprising combining the pigment particle, the basic charge director and the liquid carrier.

Also described is a method of manufacturing a liquid electrophotographic (LEP) ink composition consisting essentially of:
a pigment particle having an acidic surface modification;
a basic charge director selected from:
   (i) a polymeric amine dispersant having a Total Base Number of at least 100 mg KOH/gram material, and
   (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier,
the method comprising combining the pigment particle, the basic charge director and the liquid carrier.

For the avoidance of doubt, the discussion of manufacturing methods which follows is applicable to each of the afore-mentioned methods.

In some examples, combining the pigment and the basic charge director comprises grinding the pigment and the basic charge director before combining any liquid carrier. In other examples, combining the pigment and the basic charge director comprises grinding the pigment and the basic charge director in the presence of a liquid carrier.

In some examples, the basic charge director is a liquid or is in the form of a solution and is combined with the pigment to form a slurry. In some examples, the basic charge director is a liquid or is in solution form and is ground with the pigment to form a slurry. In some examples, the basic charge director is a solid and is ground with the pigment in the presence of a liquid carrier or in the absence of a liquid carrier.

In some examples, the method comprises combining a basic charge director and the pigment in amounts to provide an agent on weight of pigment (AOWP) percentage of from 0.1% to 30%, for example from 0.2% to 25%, for example from 1% to 25%, for example from 5% to 20%. It will be understood that AOWP percentage refers to the effective amount of basic charge director on pigment based on pigment surface area. For example, a dosage of 2 mg active dispersant on weight of pigment is the pigment surface area divided by 5.

In some examples, the method comprises combining the pigment, the basic charge director and optionally the liquid carrier, and grinding at a grinding speed of at least 500 rpm. In some examples, the method comprises grinding at a grinding speed of at least 1000 rpm, for example at least 1500 rpm, for example at least 2000 rpm, for example at least 2500 rpm, for example at least 3000 rpm, for example at least 3500 rpm, for example at least 4000 rpm, for example up to 4500 rpm. In some examples, the method comprises grinding at a grinding speed from 1000 rpm to 4500 rpm, for example from 1000 rpm to 4500 rpm, for example from 2000 to 4000 rpm, for example from 2500 to 3500 rpm.

In some examples, the method comprises combining the pigment, the basic charge director and optionally the liquid carrier, and grinding with a grinding media having a particle size of from 0.7 mm to 0.05 mm, thus enabling not only pigment particles having a sub-micron particle size but also an intimate mixing of the basic charge director with the acidic surface of the pigment.

In some examples, the method comprises grinding for at least 1 h, in some examples, for at least 2 h. In some examples, the method comprises grinding for up to about 12 h. In some examples, the method comprises grinding at a temperature of no more than about 30° C., for example, no more than about 20° C., for example, no more than about 15° C., for example, no more than about 10° C., for example no more than about 5° C.

### Method of Electrophotographic Printing

Described herein is a method of electrophotographic printing, comprising:
forming a latent electrophotographic image on a surface; and
contacting the surface with a liquid electrophotographic (LEP) ink composition comprising:
   a pigment particle having an acidic surface modification;
   a basic charge director selected from:
      (i) a polymeric amine dispersant having a Total Base Number of at least 100 mg KOH/gram material, and
      (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier, wherein the ink composition does not include a thermoplastic resin, such that at least some of the particles adhere to the surface to form a developed toner image on the surface; and transferring the toner image to a print medium.

Also described herein is a method of electrophotographic printing, comprising:
forming a latent electrophotographic image on a surface; and
contacting the surface with a liquid electrophotographic (LEP) ink composition consisting of:
   a pigment particle having an acidic surface modification;
   a basic charge director selected from:
      (i) a polymeric amine dispersant having a Total Base Number of at least 100 mg KOH/gram material, and
      (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier, such that at least some of the particles adhere to the surface to form a developed toner image on the surface; and transferring the toner image to a print medium.

Also described herein is a method of electrophotographic printing, comprising:
forming a latent electrophotographic image on a surface; and
contacting the surface with a liquid electrophotographic (LEP) ink composition consisting essentially of:
   a pigment particle having an acidic surface modification;
   a basic charge director selected from:
      (i) a polymeric amine dispersant having a Total Base Number of at least 100 mg KOH/gram material, and
      (ii) a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I); and
a liquid carrier, such that at least some of the particles adhere to the surface to form a developed toner image on the surface; and transferring the toner image to a print medium.

For the avoidance of doubt, the discussion of printing methods which follows is applicable to each of the afore-mentioned methods.

In some examples, the method of printing may comprise printing a plurality of different ink compositions to form an image on a print medium, at least one of which comprises an ink composition as described above. In some examples, the ink composition is a yellow ink composition.

In some examples, the method of printing may comprise printing a yellow ink composition as described above, and further comprise printing a black ink composition, a cyan ink composition, a magenta ink composition and a white ink composition.

In some examples, the method of printing may comprise liquid electrophotographically printing the ink composition onto a substrate by contacting the ink composition with a latent electrostatic image on a surface to create a developed image and transferring the developed image to a print medium, in some examples, via an intermediate transfer member.

In some examples, the surface on which the (latent) electrostatic image is formed or developed may be on a rotating member, e.g., in the form of a cylinder. The surface on which the (latent) electrostatic image is formed or developed may form a part of a photo imaging plate (PIP). The method may involve passing the ink composition between a stationary electrode and a rotating member, which may be a member having the surface having the (latent) electrostatic image thereon or a member in contact with the surface having the (latent) electrostatic image thereon. A voltage is applied between the stationary electrode and the rotating member, such that particles adhere to the surface of the rotating member. The intermediate transfer member, if present, may be a rotating flexible member, which may be heated, e.g., to a temperature of from 80 to 160° C.

The print medium may also be referred to herein as a substrate, or a print substrate. The print medium or substrate may be any suitable substrate. The substrate may be any suitable substrate capable of having an image printed thereon. The substrate may include a material selected from an organic or inorganic material. The material may include a natural polymeric material, e.g., cellulose. The material may include a synthetic polymeric material, e.g., a polymer formed from alkylene monomers, including, for example, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g., a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic print substrate such as paper. The cellulosic print substrate is, in some examples, a coated cellulosic print. In some examples, a primer may be coated onto the print substrate, before the liquid electrostatic ink composition is printed onto the print substrate.

In some examples, the print medium comprises any suitable textile or fabric substrate. In some examples, the textile or fabric substrate may be a network of natural or synthetic fibres. The fabric substrate may be woven or non-woven. The textile or fabric substrate may be formed of yarns, for example, spun threads or filaments, which may be natural or synthetic material or a combination thereof. The textile or fabric substrate may include substrates that have fibres that may be natural and/or synthetic. The substrate may comprise any textile, fabric material, fabric clothing, or other fabric product onto which it is desired to apply printed matter. The term “textile” includes, by way of example, cloth, fabric material, fabric clothing or other fabric products. The textile substrate may have warp and weft yarns. The terms “warp” and “weft” refer to weaving terms that have their ordinary meaning in the textile arts, that is, warp refers to lengthwise or longitudinal yarns on a loom whereas weft refers to crosswise or transverse yarns on a loom. The textile substrate may be woven, non-woven, knitted, tufted, crocheted, knotted, and/or have a pressed structure.

In some examples, the print medium may include a metal, which may be in sheet form. In some examples, the substrate may comprise a metallic foil or a metallized substrate. In some examples, the substrate may comprise an aluminium foil. In some examples, the substrate may comprise a metallized paper (i.e., paper having a metal layer thereon) or a metallized plastic substrate (i.e., a plastic substrate having a metal layer thereon). The metal may be selected from or made from, for example, aluminium (Al), silver (Ag), tin (Sn), copper (Cu), or mixtures thereof.

In some examples, the print medium is a polymer substrate. In some examples, the polymer substrate may be a copolymer. In some examples, the polymer substrate may be a polymer formed from alkylene monomers. In some examples, the polymer substrate may comprise an acrylic substrate. In some examples, the polymer substrate comprises acrylic, polyester, nylon, polyethylene (PE), linear low density polyethylene (LLDPE), low density polyethylene (LDPE), medium density polyethylene (MDPE), high density polyethylene (HDPE), polypropylene (PP), cast polypropylene (cPP), biaxially oriented polypropylene (BOPP), polyamide (PA), oriented polyamide (OPA), or polyethylene terephthalate (PET) and combinations thereof.

In some examples, the substrate may comprise a plurality of layers of material, in some examples, a plurality of layers of material laminated together. In some examples, the substrate may comprise a plurality of layers of material selected from polymeric materials (e.g., polymeric materials selected form PE, LLDPE, MDPE, PP, cPP, BOPP, PA, OPA and PET), metallic materials (e.g., metallic foils such as aluminium foil, or metallized substrates such as metallized-PET or metallized BOPP), paper and combinations thereof. In some examples, the substrate comprises a plurality of layers of polymeric material (such as a combination of layers selected from PE, LLDPE, MDPE, PP, BOPP, PET and OPA) laminated together. The substrate may comprise a plurality of layers of polymeric material laminated together, wherein each layer is independently selected from PE, LLDPE, MDPE, PP, BOPP, PET and OPA. In some examples, the substrate is a flexible material substrate, such as may be used in packaging.

In some examples, the substrate comprises polypropylene and the polypropylene is corona treated before the electrostatic ink composition is electrostatically printed on the surface of the polypropylene.

In some examples, the substrate comprises polyethylene terephthalate and no corona treatment is used before the electrostatic ink composition is electrostatically printed on the surface of the polypropylene.

The print medium may comprise a fabric substrate, a cellulosic substrate, or a polymer substrate selected from acrylic, polyester, nylon, polyethylene (PE), linear low density polyethylene (LLDPE), low density polyethylene (LDPE), medium density polyethylene (MDPE), high density polyethylene (HDPE), polypropylene (PP), cast polypropylene (cPP), biaxially oriented polypropylene (BOPP), polyamide (PA), oriented polyamide (OPA), or polyethylene terephthalate (PET) and combinations thereof.

In some examples, the substrate has a thickness of 300 μm or less, for example, 250 μm or less, 200 μm or less, 150 μm or less, 100 μm or less, 90 μm or less, 80 μm or less, 70 μm or less, 60 μm or less, 50 μm or less, 40 μm or less, 30 μm or less, 20 μm or less, or 15 μm or less. In some examples, the substrate has a thickness of 15 μm or more, for example, 20 μm or more, 30 μm or more, 40 μm or more, 50 μm or more, 60 μm or more, 70 μm or more, 80 μm or more, 90 μm or more, or 100 μm or more. In some examples, the substrate has a thickness of 15 μm to 100 μm, for example, 20 μm to 90 μm, 30 μm to 80 μm, 40 μm to 70 μm, or 50 μm to 50 μm.

In some examples, the substrate comprises a thermally activatable laminating layer on a surface of the substrate and the electrophotographic ink composition is transferred from the photoimaging plate onto the thermally activatable laminating material of the substrate present on an intermediate transfer member.

The thermally activatable laminating material may be activated prior to transfer of the electrophotographic ink composition to the thermally activatable laminating material. Activating the thermally activatable laminating material can increase the adhesion of the electrophotographic ink composition to the thermally activatable laminating material, improving transfer of the electrophotographic ink composition Activation of the thermally activatable laminating material may comprise heating the thermally activatable laminating material to a temperature above the melting point of the thermally activatable laminating material, for example heating to a temperature of at least 5° C. above the melting point, for example, at least 6° C. above the melting point, at least 7° C. above the melting point, at least 8° C. above the melting point, at least 9° C. above the melting point, or at least 10° C. above the melting point of the thermally activatable laminating material. In some examples, activation of the thermally activatable laminating material comprises heating the thermally activatable material to a temperature of from 10° C. above the melting point to 5° C. above the melting point of the thermally activatable laminating material. The melting point may be determined by differential scanning calorimetry, for example, using ASTM D3418 (for example, using a heating rate of 10° C./min).

The thermally activatable laminating layer may comprise a polymer resin, for example, a thermoplastic polymer resin. In some examples, the thermally activatable laminating layer comprises a low melting polymer. The term “low melting polymer” is to be understood as a polymeric material which is solid at room temperature but melts at a temperature typically obtainable in an electrophotographic printer.

In some examples, the thermally activatable laminating material comprises a low melting polymer with a melting point of about 140° C. or less, for example, about 130° C. or less, about 120° C. or less, about 110° C. or less, about 100° C. or less, about 95° C. or less, about 90° C. or less, about 85° C. or less, about 80° C. or less, about 75° C. or less, about 70° C. or less, or about 65° C. or less. In some examples, the thermally activatable laminating material comprises a low melting polymer with a melting point of about 65° C. or more, for example, about 70° C. or more, about 75° C. or more, about 80° C. or more, about 85° C. or more, about 90° C. or more, about 95° C. or more, about 100° C. or more, about 110° C. or more, about 120° C. or more, about 130° C. or more, about 140° C. or more. In some examples, the thermally activatable laminating material comprises a low melting polymer with a melting point of from about 65° C. to about 140° C., for example, about 70° C. to about 130° C., about 75° C. to about 120° C., about 80° C. to about 110° C., about 85° C. to about 100° C., about 65° C. to about 95° C., about 70° C. to about 90° C.

By using a low melting polymer as the thermally activatable laminating material it becomes possible to adhere the substrate to a second substrate, for example a second flexible material at the temperatures used in an electrophotographic printer, for example, the temperature of the intermediate transfer member.

In some examples, the thermally activatable laminating material comprises a thin film of a polymer, wherein the film is less than 50 μm in thickness, for example, less than 40 μm in thickness, less than 30 μm in thickness, less than 20 μm in thickness, less than 15 μm, less than 14 μm in thickness, less than 13 μm in thickness, less than 12 μm in thickness, less than 11 μm in thickness, less than 10 μm in thickness, less than 8 μm in thickness. In one example, the film of polymer is about 13 μm in thickness.

In some examples, the thermally activatable laminating layer or material comprises a thin film of a polymer, wherein the film is greater than 8 μm in thickness, for example greater than 10 μm in thickness, greater than 11 μm in thickness, greater than 12 μm in thickness, greater than 13 μm in thickness, greater than 14 μm in thickness, greater than 15 μm in thickness, greater than 20 μm in thickness, greater than 30 μm in thickness, greater than 40 μm in thickness, greater than 50 μm in thickness.

In some examples, the thermally activatable laminating material comprises a copolymer of an alkylene monomer (for example, ethylene or propylene) and a monomer selected from alkenyl esters (e.g., vinyl acetate), acrylates and methacrylates. In some examples, the thermally activatable laminating material comprises a copolymer selected from ethylene vinyl acetate (EVA) and ethylene methyl acrylate (EMA).

In some examples, the polymer may be selected from ethylene or propylene acrylic acid co-polymers; ethylene or propylene methacrylic acid co-polymers; ethylene vinyl acetate co-polymers; co-polymers of ethylene or propylene (e.g. 80 wt % to 99.9 wt %), and alkyl (e.g. C1 to C5) ester of methacrylic or acrylic acid (e.g. 0.1 wt % to 20 wt %); co-polymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); co-polymers of ethylene or propylene (e.g. 70 wt % to 99.9 wt %) and maleic anhydride (e.g. 0.1 wt % to 30 wt %); polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers, urethane polymers and combinations thereof. In some examples, the polymer may be an ethylene vinyl acetate copolymer.

The thermally activatable laminating material may comprise a polymer that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The thermally activatable laminating material may comprise a thermoplastic polyurethane. Thermoplastic polyurethanes are formed during a polyaddition reaction between a diisocyanate, a polyol or long-chain diol and a chain extender or short-chain diol. Suitable thermoplastic polyurethanes include the Irogran®, Avalon®, Krystalgran® and Irostic® families available from Huntsman, and the Pureseal family of polymers from Ashland.

The thermoplastic polyurethane may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the thermally activatable laminating material can in some examples be selected from the Nucrel family of polymers (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, Bynell 2020 and Bynell 2022, (sold by E. I. du PONT)), the AC family of polymers (e.g. AC-5120, AC-5180, AC-540, AC-580 (sold by Honeywell)), the Aclyn family of polymers (e.g. Aclyn 201, Aclyn 246, Aclyn 285, and Aclyn 295), the Lotader family of polymers (e.g. Lotader 2210, Lotader, 3430, and Lotader 8200 (sold by Arkema)), the Lotryl family of polymers (e.g. Lotryl MA03 (sold by Arkema)), the Escor family of polymers (e.g. Escor 5020 7.5% (sold by Exxon Mobil), the Tafmer family of polymers (e.g. Tafmer MA9015 (sold by Mitsui)) and the Surlyn family of polymers (e.g. Surlyn 1652 (sold by DuPont)).

Heated air can be applied (for example, by IR lamps) to an image layer on the thermally activatable laminating material on the intermediate transfer member to evaporate the carrier liquid of the liquid electrophotographic ink composition.

In the methods described, transferring the toner image to a print medium may comprise forming an image layer on the print medium with an additional step of contacting, under conditions of heat and/or pressure, the image layer with a second substrate to form a laminated flexible packaging material. The heat can activate the thermally activatable laminating material, thereby forming the flexible packaging material. Activating the thermally activatable laminating material comprises softening, in some examples, melting, the thermally activatable laminating material. In some examples, the conditions of heat and/or pressure comprise heating to a temperature below the melting point of the substrate and the second substrate.

In some examples, the image layer is contacted with the second substrate at a temperature of at least about 50° C., for example, at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., at least about 145° C., or at least about 150° C.

The image layer may be contacted with the second substrate at a temperature of up to about 150° C., for example, up to about 145° C., up to about 140° C., up to about 135° C., up to about 130° C., up to about 125° C., up to about 120° C., up to about 115° C., up to about 110° C., up to about 105° C., up to about 100° C., up to about 95° C., up to about 90° C., up to about 85° C., up to about 80° C., up to about 75° C., up to about 70° C., up to about 65° C., up to about 60° C., up to about 55° C., or up to about 50° C. In some examples, the image layer is contacted with the second substrate at a temperature in the range of 50° C. to 150° C. for example, about 55° C. to about 150° C., about 60° C. to about 145° C., about 65° C. to about 140° C., about 70° C. to about 135° C., about 75° C. to about 130° C., about 80° C. to about 125° C., about 85° C. to about 120° C., about 90° C. to about 115° C., about 95° C. to about 110° C., or about 100° C. to about 105° C. It would be understood that the temperature required for efficient thermal lamination will depend on the nature or composition of the thermally activatable laminating material.

In some examples, the pressure is at least about 10 kg of pressure, for example, at least about 15 kg, at least about 20 kg, at least about 25 kg, at least about 30 kg, at least about 35 kg, at least about 40 kg, at least about 45 kg, at least about 50 kg of pressure. In some examples, the pressure is up to about 50 kg of pressure, for example, up to about 45 kg, up to about 40 kg, up to about 35 kg, up to about 30 kg, up to about 25 kg, up to about 20 kg, up to about 15 kg, up to about 10 kg of pressure. In some examples, the pressure is from about 10 kg to about 50 kg, for example, about 15 kg to about 45 kg, about 20 kg to about 40 kg, about 25 kg to about 35 kg, about 25 kg to about 30 kg.

The second substrate may be any flexible material suitable for use in a printing process and suitable for use in a flexible packaging material. In some examples, the second substrate comprises one or more of paper, metallic foil, and a polymeric substrate.

The second substrate may comprise a polymer, for example, a film of a polymer. In some examples, the second substrate comprises a thermoplastic polymer. In some examples, the second substrate comprises biaxially oriented polypropylene (BOPP), polyethylene terephthalate (PET), polyethylene-ethylene vinyl alcohol (PE-EVOH), cast polypropylene (CPP), Nylon (e.g., oriented polyamide (OPA)), polyethylene (PE), linear low density polyethylene (LLDPE), low density polyethylene (LDPE), medium density polyethylene (MDPE), high density polyethylene (HDPE), PET-PE, Metalized PET/PE, polypropylene (PP), biaxially oriented polypropylene (BOPP).

The second substrate may comprise a metallized paper in the form of a paper substrate coated on one surface with a layer of metal, for example, aluminium. In some examples, the second substrate comprises a metallized plastic film in the form of a polymer substrate coated on one surface with a layer of metal, for example, aluminium. In some examples, the second substrate comprises a metallized BOPP film, a metallized PET film, or a metallized polyethylene (PE) film. In some examples, the PET may comprise PET-silicon oxide, PET-aluminium oxide, polyethylene terephthalate-poly(vinyl alcohol) (PET-PVOH) or polyethylene terephthalate-polyvinylidene dichloride (PET-PVDC).

In some examples, the second substrate may be the innermost layer of a flexible packaging material in use. In some examples, the second substrate may be referred to as a functional substrate. In some examples, the functional substrate may be functional in the sense that it provides a barrier function to protect the packaged goods. In some examples, the second substrate may serve as a barrier to any external influence that could damage or otherwise reduce the quality of the packaged goods, in particular food, by preventing ingress of, for example, moisture, oxygen, other oxidants and pathogens such as viruses and bacteria.

In some examples, the second substrate comprises a film or sheet, e.g., a thin film or sheet, of paper, metallic foil, and/or plastic. In some examples, the second substrate comprises a metallic foil, a metallized substrate or a paper substrate. In some examples, the second substrate comprises a metallized paper or a metallized plastic film. In some examples, the second substrate comprises an aluminium foil. In some examples, the second substrate is a polymeric flexible material. In some examples the second substrate comprises a film of a plastic material, for example, polyethylene (PE), linear low density polyethylene (LLDPE), low density polyethylene (LDPE), polypropylene (PP), biaxial oriented polypropylene (BOPP), or polyethylene terephthalate.

The second substrate may comprise a metallized paper in the form of a paper substrate coated on one surface with a layer of metal, for example aluminium. In some examples, the second substrate comprises a metallized plastic film in the form of a polymer substrate coated on one surface with a layer of metal, for example aluminium. In some examples, the second substrate comprises a metallized plastic film in the form of a metallized BOPP film, a metallized PET film, or a metallized polyethylene (PE) film.

In some examples, the second substrate comprises a plurality of layers of film of material laminated together to form a pre-laminated flexible material. In some examples, the second substrate comprises a plurality of layers of material selected from polymeric materials (e.g. polymeric materials selected from PE, LLDPE, MDPE, PP, BOPP, PET and OPA), metallic materials (e.g. metallic foils such as aluminium foil, or metallized films such as MET-PET (e.g. Al/PET), MET-BOPP (e.g. Al/BOPP), MET-BOPA (e.g. Al/BOPA) or any other metalized substrate), paper and combinations thereof. In some examples, the second substrate comprises a plurality of layers of film of a plastic material, such as a combination of films selected from PE, LLDPE, MDPE, PP, BOPP, PET and OPA, laminated together to form a pre-laminated flexible material. In some examples, the pre-laminated flexible material comprises an aluminium layer. In some examples, the pre-laminated flexible material comprises a Paper/Alu/PE, PET/Al/PE, BOPP/MET-BOPP, Al/BOPA/PE or PET/PE laminate.

In some examples, the second substrate comprises a film of a polymer, wherein the film is less than 100 μm in thickness, for example less than 50 μm in thickness, for example less than 45 μm in thickness, for example less than 40 μm in thickness, for example less than 35 μm in thickness, for example less than 30 μm in thickness, for example less than 25 μm in thickness, for example less than 20 μm in thickness, for example less than 15 μm in thickness, for example less than 10 μm in thickness, for example less than 5 μm in thickness. In some examples, the film of polymer is about 20 μm in thickness.

In some examples, the second substrate comprises a film of a polymer, wherein the film is greater than 5 μm in thickness, for example greater than 10 μm in thickness, for example greater than 15 μm in thickness, for example greater than 20 μm in thickness, for example greater than 25 μm in thickness, for example greater than 30 μm in thickness, for example greater than 35 μm in thickness, for example greater than 40 μm in thickness, for example greater than 45 μm in thickness, for example greater than 50 μm in thickness.

In some examples, a primer is applied to the second substrate before the second substrate is contacted with the image layer.

In some examples, the primer comprises a primer resin. In some examples, the primer resin may be selected from the group comprising or consisting of hydroxyl containing resins, carboxylic group containing resins, and amine based polymer formulations. In some examples, a hydroxyl containing resin may be selected from polyvinyl alcohol resins, e.g. polyvinyl alcohol based such as polyvinyl butyral formulations (Butvar, Eastman), Vinnol® (Wacker polymers), cellulose derivative additives (Eastman), polyester (Dynapol, Evonic) and polyurethane based formulations with hydroxyl groups.

In some examples, the carboxylic group containing resins may be selected from: olefin co-acrylic or methacrylic acid based copolymers, polyacrylic acid based polymers, and polylactic acid based polymers. In some examples, the amine based polymer formulations may be selected from polyamines and polyethylene imines. The primer resin may be selected from the group comprising, or consisting of, a polyvinyl alcohol resin, cellulose based resins, a polyester, a polyamine, a polyethylene imine resin, polyamide resin, polyurethane, copolymers of an alkylene monomer and an acrylic or methacrylic acid monomer, and polyacrylic polymers.

In some examples, the primer resin comprises a carboxylic functional group, an amine functional group or a polyol functional group. In some examples, the primer resin comprises an amine functional group or a carboxylic functional group.

In some examples, the primer resin comprises an amine functional group. In some examples, the primer resin comprises or consists of a polyethylene imine resin. Examples of a material suitable as a primer are DP050 and DP680 (available from Michelman, Inc.). In some examples, the primer on the surface of the second substrate comprises a crosslinked primer resin.

In some examples, the primer is provided in an amount such that the coat weight of the primer resin on the second substrate is at least 0.01 g/m², in some examples, at least 0.05 g/m², in some examples, at least 0.1 g/m², in some examples, at least 0.15 g/m², in some examples, at least 0.18 g/m², in some examples, at least 0.2 g/m², in some examples, at least 0.5 g/m², in some examples, at least 1 g/m², in some examples, at least about 1.5 g/m².

In some examples, the primer is provided in an amount such that the coat weight of the primer resin on the second substrate is up to about 0.01 g/m², in some examples, up to about 0.05 g/m², in some examples, up to about 0.1 g/m², in some examples, up to about 0.15 g/m², in some examples, up to about 0.18 g/m², in some examples, up to about 0.2 g/m², in some examples, up to about 0.5 g/m², in some examples, up to about 1 g/m², in some examples, up to about 1.5 g/m².

In some examples, the primer is provided in an amount such that the coat weight of the primer resin on the second flexible material is 0.01 g/m² to 1.5 g/m², in some examples, 0.05 g/m² to 1 g/m², in some examples, 0.1 g/m² to 0.5 g/m², in some examples, 0.15 g/m² to 0.2 g/m², in some examples, 0.18 g/m² to 0.2 g/m².

In some examples, the second substrate has a primer on a first surface and the image layer is contacted with the first surface of the second flexible substrate. In some examples, the second substrate has a first surface on which image layer is contacted, with a second surface of the second substrate forming the outermost surface of a flexible packaging material. The second surface of the second substrate is a surface other than the surface on which the ink composition is contacted, for example, the second surface of the second substrate may be a surface opposing the first surface of the second substrate.

The second substrate may be contacted with the image layer on a first surface of the second substrate. The image may be contacted with the first surface of the second substrate in reverse with a second surface of the second substrate forming the outermost surface of a flexible packaging material and the image appearing the right way round when viewed through the second surface of the second substrate.

Alternatively, the image may be transferred onto a thermally activatable laminating material of the layered substrate on the ITM in reverse with the first substrate forming the outermost surface of the flexible packaging material and the image appearing the right way round when viewed through the layered substrate. Thus, the image is embedded within the multi-layer structure of the flexible packaging material and not on the outermost surface, and thus is protected from damage.

### Printed Substrate

In some examples, there is provided a printed substrate, having thereon a printed image consisting of a pigment particle having an acidic surface modification.

In some examples, the substrate and pigment particle are as described above.

### EXAMPLES

The following illustrates examples of the methods and other aspects described herein. Thus, these Examples should not be considered as limitations of the present disclosure, but are merely in place to teach how to make examples of the present disclosure.

### Materials

### Pigment

Pigment Yellow 185 (PY185) available from BASF, comprising sulfonic acid surface modifications.

Pigment Yellow 74 (PY74) available from Clariant, comprising acid surface modifications.

### Charge Director

Polymeric Amine Dispersant: Solplus™ P6000 (50 wt. % active dispersant in dipropylene glycol; TBN number 400 mg KOH/gram sample), Solsperse™ 13300 (50% actives dispersant in SHELLSOL™ D40; 200-250 mg KOH/gram sample) available from Lubrizol™.

SCD: Sulfosuccinate salt: bis tridecyl barium sulfosuccinate (5 wt % actives in Isopar L™).

### Carrier Liquid

Isopar L™: an isoparaffinic oil comprising a mixture of C11-C13 isoalkanes; produced by Exxon Mobil™; CAS number 64742-48-9.

### Print Media

Platinum PetPRO™ (available from Nobelus™ company): a layered substrate (thickness: 25 μm) comprising an ethylene vinyl acetate (EVA) adhesive (thickness: 13 μm; thermally activatable laminating material) disposed on a polyethylene terephthalate (PET) film (thickness: 12 μm).

Biaxially oriented polypropylene (BOPP; available from Jolybar™ company): a semi-matte transparent film with a thickness of 20 μm (second substrate).

### Primer

DigiPrime™ 680 (available from Michelman™): an aqueous primer formulation comprising a polyethylene imine resin.

### General Procedure—Preparation of the Ink

The ink was prepared by mixing the components of Table 1 below in an Eiger™ milling instrument (with milling media of 0.63 mm), and milling at speeds of up to 5000 rpm at 4° C. for 1 to 3 hours.

TABLE 1

| | | | | Charge | | | Milling | Milling |
|---|---|---|---|---|---|---|---|---|
| | | Pigment | | Director | | | Time | speed |
| Example | Pigment | Weight | Charge Director | Amount | | Isopar | (hours) | (RPM) |
| 1 | PY185 | 20 g | SCD | 9 | g | 171 g | 1 | 4960 |
| 2 | PY185 | 20 g | SCD | 9 | g | 171 g | 3 | 4960 |
| 3 | PY74 | 20 g | SCD | 9 | g | 171 g | 1 | 2790 |
| 4 | PY74 | 20 g | SCD | 9 | g | 171 g | 3 | 2790 |
| 5 | PY185 | 10 g | Solplus ™ P6000 | 10 | g | 180 g | 1 | 4960 |
| 6 | PY185 | 10 g | Solplus ™ P6000 | 10 | g | 180 g | 3 | 4960 |
| 7 | PY185 | 10 g | Solsperse ™ 13300 | 10 | g | 180 g | 3 | 4960 |
| 8 | PY185 | 10 g | Solplus ™ P6000 | 10 | g | 180 g | 3 | 4960 |
| 9 | PY185 | 10 g | Solsperse ™ 13300 | 4 | g | 186 g | 1 | 4960 |
| 10 | PY185 | 10 g | Solsperse ™ 13300 | 4 | g | 186 g | 3 | 4960 |

### Tests

### Particle Conductivity

The charging of the ink compositions (at the indicated pigment loading) was studied using the different charge directors. The following test was performed on each in order to characterize the ink before printing in press:

The particle conductivity (PC) was calculated by subtracting the low field conductivity (LF) from the high filed conductivity (HF), where LF was measured using an LF probe and HF was measured by a Q/M device that measures electrophoretic conductivity at high field (PC=HR-LF; measured in pmho).

The low field conductivity is the electrical conductivity of the in composition measured under the following conditions:

Electrical field amplitude: 5-15 V/mm;

Frequency: 5-15 Hz;

Temperature: 23±2° C.

The high field conductivity is the maximum electrical conductivity of the ink measured under the following conditions:

Electrical field pulse:
Shape: rectangular;
Height: 1500 V/mm;
Duration: 8 s;
Rise time: 1 ms or less;
Ripple: 10 V/mm or less;

Sampling frequency: 1000 per second;

Temperature: 23±2° C.

DC (direct current) conductivity is the average conductivity measured in phmo/cm between 6.4 and 7.2 seconds.

The results are shown in Table 2.

TABLE 2

| | DC Conductivity | Particle Conductivity |
|---|---|---|
| Example | (phmo/cm) | (pmho/cm) |
| 1 | 40.93 | 200 |
| 2 | 1325.01 | 770 |
| 3 | 625.75 | 340 |
| 4 | 325.2 | 560 |
| 5 | 5384.97 | 600 |
| 6 | 2145.52 | 300 |
| 7 | 131.6 | 90 |
| 8 | 1061.66 | 375 |
| 9 | 4.48 | 25 |
| 10 | 0.61 | 3.6 |

As can be seen in Table 2, ink compositions in accordance with the present disclosure i.e. not having polymeric resins, have good levels of particle conductivity.

### Printing

A flexible packaging material having a printed image using the inks as prepared above was prepared as follows.

The intermediate transfer member (ITM) was installed in an HP Indigo WS6600 printing press comprising an in-line priming unit and a substrate unwinder. The BOPP substrate was installed on the substrate unwinder of the printing press. The in-line priming unit applied the primer to the BOPP (see Table 3) and the primed BOPP was heated at 60° C. to dry the primer.

TABLE 3
in-line primer application

| | |
|---|---|
| Primer | DP680 |
| Intermediate coating roller | 82 mm rough surface |
| Coating level | Medium |
| Drying temperature [° C.] | 60 |
| Corona intensity [W] | 800 |
| Heat sensitivity | High |

The layered substrate Platinum PetPRO was contacted with the ITM with the PET surface in contact with the ITM.

The liquid electrophotographic (LEP) printer was then used to print an image layer using the ink composition onto the adhesive layer of the Platinum PetPRO and contact (under conditions of heat and/or pressure) the image layer with the primer on the BOPP, thereby forming a flexible packaging material. Thus, a latent electrostatic image was formed on the photoimaging plate of the LEP printer and then a single colour LEP ink composition was transferred to the electrically charged portions of the latent image on the photoimaging plate.

The LEP ink composition was then transferred from the photoimaging plate to the adhesive layer of the Platinum PetPRO (on the intermediate transfer member of the LEP printer), forming an image layer on the adhesive layer. The ITM was at temperature of 95° C. and heated air was applied to the ITM at a temperature of 110° C. The heating of the ITM and the air temperature caused the carrier liquid in the LEP ink composition to evaporate and at least the pigment particles in the LEP ink to form a film on the surface of the EVA, and caused the EVA to soften (by heating to a temperature above the melting point of EVA). A feed fan (8 V) is used to remove evaporating liquid carrier from the area.

Four further LEP ink compositions were then sequentially transferred to the EVA from the photoimaging plate to form a full colour image. Then, the movement of the ITM transferred the printed substrate into contact with the primer on the BOPP. Pressure (20 kg) is applied and the ITM temperature continues to apply heat (95° C.) that activates the EVA adhesive, which adheres the Platinum PetPRO to the BOPP with the EVA, image layer and primer disposed between them. The five coloured LEP ink compositions used were a yellow composition in accordance with the present disclosure, and cyan, magenta, black (key) and white.

Tests showed that the complete LEP ink image was transferred from the photoimaging plate to the print medium. Furthermore, the ink/EVA/PET was also completely transferred from the ITM to the BOPP film, forming the flexible packaging material.

While the compositions, methods and related aspects have been described with reference to certain examples, those skilled in the art will appreciate that various modifications, changes, omissions, and substitutions can be made without departing from the spirit of the disclosure. It is intended, therefore, that the invention be limited by the scope of the following claims. The features of any dependent claim may be combined with the features of any of the other dependent claims and/or any of the independent claims.

1. A liquid electrophotographic (LEP) ink composition, comprising:
a pigment particle having an acidic surface modification;
a basic charge director selected from:
(i) a polymeric amine dispersant having a Total Base Number of at least 100 mg KOH/gram material, and
(ii) a sulfosuccinate salt of the general formula MAₙ, wherein M is a metal, n is the valence of M, and A is an ion of the general formula (I):
[R¹—O—C(O)CH₂CH(SO₃)C(O)—O—R²]⁻ (I); and
a liquid carrier,
wherein the ink composition does not include a thermoplastic resin.

2. The liquid electrophotographic ink composition of claim 1, wherein the pigment is present in the composition in an amount of at least 5 wt %, based on the total weight of the composition.

3. The liquid electrophotographic ink composition of claim 1, wherein the basic charge director is present in the composition in an amount of from 2 wt % to 10 wt %, based on the amount of active dispersants in the total weight of the composition.

4. The liquid electrophotographic ink composition of claim 1, wherein the acidic surface modification comprises an organic acid, a sulfonic acid or an inorganic acid, or a mixture thereof, adsorbed onto the surface of the pigment particle.

5. The liquid electrophotographic ink composition of claim 1, wherein the acidic surface modification comprises a Lewis acid selected from borane, a boron trihalide, for example boron trifluoride, or an organoborane, or silicon tetrafluoride, or an aluminium trihalide adsorbed onto the surface of the pigment particle.

6. The liquid electrophotographic ink composition of claim 1, wherein the acidic surface modification of the pigment comprises or derives from (i) a carboxylic acid selected from methanoic acid, ethanoic acid, propionic acid, butanoic acid, pentanoic acid, hexanoic acid, oxalic acid, maleic acid, tartaric acid, citric acid, succinic acid, benzoic acid, stearic acid, gallic acid, salicylic acid, ascorbic acid and mixtures thereof; (ii) a sulfonic acid selected from methanesulfonic acid, benzenesulfonic acid, p-toluenesulfonic acid, triflic acid and taurine and mixtures thereof; or (iii) an inorganic acid such as hydrofluoric acid, hydrochloric acid, hydrobromic acid, hydroiodic acid, nitric acid, nitrous acid, sulfuric acid, boric acid, phosphoric acid, or perchloric acid and mixtures thereof.

7. The liquid electrophotographic ink composition of claim 1, wherein the polymeric amine dispersant comprises a polyhydroxy stearic acid chain.

8. The liquid electrophotographic ink composition of claim 1, wherein the polymeric amine dispersant has a Total Base Number of about 400 mg KOH/gram material.

9. The liquid electrophotographic ink composition of claim 1, wherein the basic charge director is a sulfosuccinate salt and wherein each of R¹ and R² is independently a C3 to C30 alkyl, and M is selected from Na, K, Cs, Ca, or Ba.

10. The liquid electrophotographic ink composition of claim 1, wherein the pigment particle is a yellow pigment particle.

11. The liquid electrophotographic ink composition of claim 1, wherein the basic charge director is present in the ink composition in an amount of at least 0.2 wt % by weight of the pigment, based on the amount of active charge director.

12. A method of manufacturing a liquid electrophotographic (LEP) ink composition, comprising combining:
a pigment particle having an acidic surface modification;
a basic charge director selected from:
(i) a polymeric amine dispersant having a Total Base Number of at least 100 mg KOH/gram material, and
(ii) a sulfosuccinate salt of the general formula MAₙ, wherein M is a metal, n is the valence of M, and A is an ion of the general formula (I):
[R¹—O—C(O)CH₂CH(SO₃)C(O)—O—R²]⁻ (I); and
a liquid carrier, wherein the ink composition does not include a thermoplastic resin.

13. A method of electrophotographic printing, comprising:
forming a latent electrophotographic image on a surface; and
contacting the surface with a liquid electrophotographic (LEP) ink composition comprising:
a pigment particle having an acidic surface modification;
a basic charge director selected from:
(i) a polymeric amine dispersant having a Total Base Number of at least 100 mg KOH/gram material, and
(ii) a sulfosuccinate salt of the general formula MAₙ, wherein M is a metal, n is the valence of M, and A is an ion of the general formula (I):
[R¹—O—C(O)CH₂CH(SO₃)C(O)—O—R²]⁻ (I); and
a liquid carrier, wherein the ink composition does not include a thermoplastic resin, such that at least some of the particles adhere to the surface to form a developed toner image on the surface; and transferring the toner image to a print medium.

14. The method of claim 13, wherein the print medium comprises a fabric substrate, a cellulosic substrate, or a polymer substrate selected from acrylic, polyester, nylon, polyethylene (PE), linear low density polyethylene (LLDPE), low density polyethylene (LDPE), medium density polyethylene (MDPE), high density polyethylene (HDPE), polypropylene (PP), cast polypropylene (cPP), biaxially oriented polypropylene (BOPP), polyamide (PA), oriented polyamide (OPA), or polyethylene terephthalate (PET) and combinations thereof.

15. The method of claim 13, wherein transferring the toner image to a print medium comprises forming an image layer on the print medium and the method further comprises contacting, under conditions of heat and/or pressure, the image layer with a second substrate to form a laminated flexible packaging material.
